(19) United States
(12) Patent Application Publication
(10) Pub. No.: US 2016/0231452 A1
(43) Pub. Date: Aug. 11, 2016

(54) TOMOSYNTHESIS IMAGING

(71) Applicant: ANALOGIC CORPORATION, Peabody, MA (US)

(72) Inventor: Daniel ABENAIM, Peabody, MA (US)

(21) Appl. No.: 15/028,481

(22) PCT Filed: Oct. 11, 2013
(86) PCT No.: PCT/US2013/064619

§ 371 Date: Apr. 11, 2016

(51) Int. Cl. G01V 5/00

(52) U.S. Cl. CPC G01V 5/005

(57) ABSTRACT

Among other things, a radiation system configured to examine an object is provided. The radiation system comprises, among other things, a radiation source, a detector array, and an object support. The object support is configured to rotate an object and to translate the object during the examination to facilitate acquiring volumetric data indicative of the object. In some embodiments, the detector array comprises a single row of detector cells and the radiation source emits fan-beam radiation. In some embodiments, the radiation system further comprises an image generator configured to generate an image of a surface of the object based upon first data corresponding to a first ray having a first trajectory and intersecting a first location within the object and second data corresponding to a second ray having a second trajectory and intersecting the first location within the object.

### BACKGROUND

The present application relates to generating via tomosynthesis one or more images respectively depicting a surface of an object under examination, which may be compiled to generate a substantially volumetric image of the object. It finds particular application with radiation systems for industrial and/or security applications where an object can be rotated during an examination to generate images depicting an interior portion of the object and/or to identify items of interest within the object (e.g., defects, threat items, etc.).

Today, radiation systems (e.g., radiation imaging systems) such as CT systems, single-photon emission computed tomography (SPECT) systems, digital projection systems, and/or line-scan systems, for example, are useful to provide information, or images, of interior items of an object under examination. The object is exposed to rays of radiation photons (e.g., x-ray photons, gamma ray photons, etc.) from a radiation source and radiation photons traversing the object are detected by a detector array positioned substantially diametrically opposite the radiation source relative to the object. A degree to which the radiation photons are attenuated by the object (e.g., absorbed, scattered, etc.) is measured to determine one or more properties of the object, which in turn may be utilized to identify items of interest. For example, highly dense items of an object typically attenuate more radiation than less dense items, and thus an item having a higher density, such as a bone or metal, for example, may be apparent when surrounded by less dense items, such as muscle or clothing. In a similar way, using such density information, a crack or anomaly in a tire, for example, may be distinguished from other portions of the tire on an image derived from the density information (e.g., on a density image where the intensity of a pixel/voxel corresponds to a density of a portion of the object represented by the pixel/voxel).

Images derived from a radiation examination may be two-dimensional or three-dimensional depending upon, among other things, the number of angles at which the object is viewed. By way of example, line-scan systems generally comprise a radiation source configured to emit fan-beam radiation and a single row of detector cells. The radiation source and line of detector cells typically do not move during the examination, and thus respective locations on the object are generally viewed from merely one angle. Accordingly, a two-dimensional projection image of the object is typically acquired. As another example, computed tomography systems generally comprise a radiation source configured to emit cone-beam radiation and a detector array configured to rotate relative to an object under examination. In this way, respective locations on the object are generally viewed from a plurality of angles to facilitate generating a three-dimensional image of the object.

### SUMMARY

Aspects of the present application address the above matters, and others. According to one aspect, a radiation system is provided. The radiation system comprises a radiation source configured to emit radiation into an examination region wherein an object is exposed to the radiation during an examination and a detector array configured to detect radiation that traverses the examination region. The radiation system also comprises an object support configured to rotate the object about an axis of rotation such that first data, indicative a first ray of radiation having a first trajectory and intersecting a first location within the object, and second data, indicative of a second ray of radiation ray having a second trajectory and intersecting the first location within the object, is yielded from the examination.

According to another aspect, a method for examining an object via radiation is provided. The method comprises rotating the object, at least partially situated within an examination region, about an axis of rotation while concurrently exposing the object to radiation. The method also comprises detecting radiation that has traversed the object and impinged a detector array to generate data. A first subset of the data is indicative a first ray of radiation having a first trajectory and intersecting a first location within the object and a second subset of the data is indicative of a second ray of radiation having a second trajectory and intersecting the first location within the object.

According to another aspect a computer readable medium comprising instructions that when executed perform operations is provided. The operations comprise rotating an object, at least partially situated within an examination region, about an axis of rotation while concurrently translating the object through the examination region and exposing the object to radiation. The operation also comprises detecting radiation that has traversed the object and impinged a detector array to generate data and defining a surface of the object that is of interest. A first location within the object intersects the surface, and the operations further comprise computing a trajectory of a first ray, intersecting the first location and detected during a first period of time, to identify a first subset of the data. The operations also comprise computing a trajectory of a second ray, intersecting the first location and detected during a second period of time, to identify a second subset of the data. The operations also comprise generating an image, focused on the surface, based upon the first subset and the second subset.

Those of ordinary skill in the art will appreciate still other aspects of the present application upon reading and understanding the appended description.

### FIGURES

The application is illustrated by way of example and is not limited by the figures of the accompanying drawings, in which like references generally indicate similar elements and in which:

FIG. 1 illustrates an example environment of a radiation system.

FIG. 2 illustrates a perspective view of an example examination unit.

FIG. 3 illustrates a perspective view of an example examination unit.

FIG. 4 illustrates a perspective view of an example examination unit.

FIG. 5 illustrates a perspective view of an example examination unit.

FIG. 6 illustrates a perspective view of an example examination unit.

FIG. 7a illustrates a cross-sectional view of an example examination unit during a first period of time.

FIG. 7b illustrates a perspective view of an example object during a first period of time.

FIG. 8a illustrates a cross-sectional view of an example examination unit during a second period of time.

FIG. 8b illustrates a perspective view of an example object during a second period of time.

FIG. 9a illustrates a cross-sectional view of an example examination unit during a third period of time.

FIG. 9b illustrates a perspective view of an example object during a third period of time.

FIG. 10 illustrates a top-down view of an example examination unit.

FIG. 11 illustrates a top-down view of an example examination unit.

FIG. 12 illustrates a top-down view of an example examination unit.

FIG. 13 is a flow diagram illustrating an example method for examining an object via radiation.

FIG. 14 is an illustration of an example computer-readable medium comprising processor-executable instructions configured to embody one or more of the provisions set forth herein.

### DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

Among other things, a radiation system configured to examine an object (e.g., tire, baggage, patient, etc.) is provided. The radiation system comprises a radiation source and a detector array. In some embodiments, the detector array comprises a limited number of rows of detector cells, such as merely one row. An examination region (e.g., a region in which an object is exposed to radiation) is defined between the radiation source and the detector array. In some embodiments, an object support is configured to translate the object during the examination while rotating the object about an axis of rotation. In some embodiments, the axis of rotation is substantially perpendicular to a plane of a detection surface of the detector array. It may be appreciated that the combination of the translation and the rotation may cause respective locations on the object to be viewed from a plurality of angles to generate volumetric data indicative of the object (e.g., where, for a given location within the object, data corresponding to at least two rays having different trajectories and converging on the given location is available).

In some embodiments, the volumetric data may be reconstructed to generate one or more of images respectively focused on a surface of the object. The surface may be planar or non-planar (e.g., curved). By way of example, in some embodiments, a plurality of images are generated respectively depicting a cross-sectional slice (e.g., parallel to a plane of a detection surface of the detector array) of the object. Moreover, in some embodiment, the volumetric data can be reconstructed to generate one or more three-dimensional images of the object (e.g., such as via a tomosynthesis reconstruction technique).

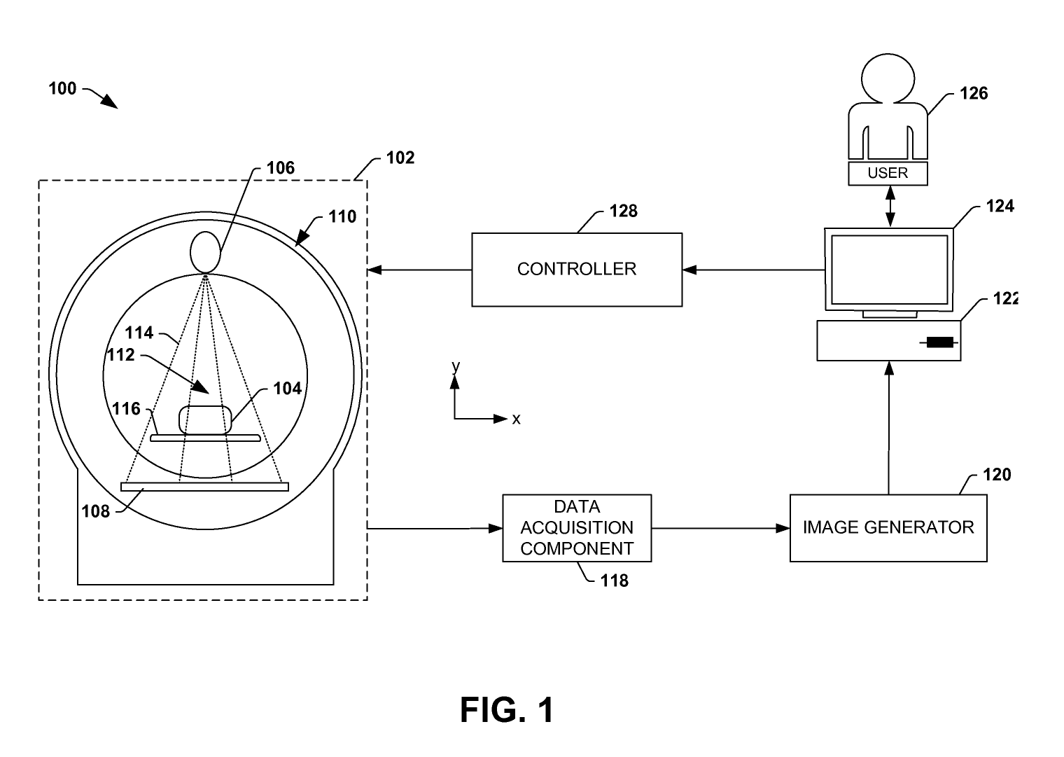

Referring to FIG. 1, an example arrangement of a radiation system 100 according to some embodiments is provided. It is to be appreciated that the example arrangement is not intended to be interpreted in a limiting manner, such as necessarily specifying the location, inclusion, and/or relative position of the components depicted therein. By way of example, in some embodiments, the data acquisition component 118 is part of the detector array 108.

An examination unit 102 of the radiation system 100 is configured to examine objects 104 (e.g., tires, baggage, patients, etc.) which may be toroid shaped, cube shaped, etc. The examination unit 102 comprises a radiation source 106 (e.g., an ionizing radiation source) and a detector array 108, which may be encased in a housing 110 to inhibit particulates from collecting on the detector array 108 and/or to shield an environment around the radiation source 106 from exposure to radiation, for example. In some embodiments, the radiation source 106 and/or detector array 108 are fixed in space (e.g., fixed in position relative to the housing 110 and/or an examination region 112).

An examination region 112, in which objects 104 are exposed to radiation 114, is defined between the radiation source 106 and the detector array 108. Objects 104 are translated through the examination region 112 (e.g., into and out of the page) via an object support 116 such as a conveyor belt or articulating arm. Objects 104 may be translated substantially continuously and/or may be translated intermittently (e.g., such as following a step-and-shoot approach where objects 104 are translated during periods when little to no radiation is being emitted and are not translated while being exposed to radiation).

Throughout the figures of the instant application, the direction of translation is labeled as the “z-axis” on the Cartesian coordinate system. The direction of translation is also sometimes referred to herein as the cone-angle direction. Moreover, a detection surface of the detector array 108 generally extends in the cone-angle direction and a fan-angle direction (e.g., which is labeled throughout the figures as the “x-axis” on the Cartesian coordinate system).

During the examination of an object 104, the radiation source 106 emits cone-beam and/or fan-beam radiation 114 from a focal spot of the radiation source 106 (e.g., a region within the radiation source 106 from which radiation 114 emanates) into the examination region 112. Such radiation 114 may be emitted substantially continuously and/or may be emitted intermittently (e.g., following the step-and-shoot approach where a brief pulse of radiation 114 is emitted followed by a resting period during which the radiation source 106 is not activated). Further, the radiation 114 may be emitted at a single energy spectra or multi-energy spectrums.

While the object 104 is being exposed to radiation and/or during resting periods between exposures, the object 104 is further rotated about an axis of rotation via an object rotator of the object support 116. In some embodiments, the axis of rotation is substantially perpendicular to a plane of the detection surface of the detector array 108 (e.g., the axis of rotation extends substantially parallel to the “y-axis”). In this way, the object 104 is rotated, within the examination region 112, in a plane substantially parallel to the detection surface of the detector array 108. In other embodiments, the axis of rotation may intersect the plane of the detection surface at an angle other than 90 degrees.

As the emitted radiation 114 traverses the object 104, the radiation 114 may be attenuated differently by different items of the object 104. Because different items attenuate different percentages of the radiation 114, the number of radiation photons detected by respective detector cells of the detector array 108 may vary. For example, more dense items within the object 104, such as metal strands, may attenuate more of the radiation 114 (e.g., causing fewer radiation photons to impinge a region of the detector array 108 shadowed by the more dense items) than less dense items, such as rubber segments.

Radiation detected by the detector array 108 may be indirectly and/or directly converted into signals that can be transmitted from the detector array 108 to a data acquisition component 118 operably coupled to the detector array 108. The signal(s) may carry information indicative of the radiation detected by the detector array 108 (e.g., such as an amount of charge measured over a sampling period, an energy of respective detected photons, etc.). The data acquisition component 118 is configured to process the signals (e.g., converting the signals from an analog domain to a digital domain, filtering the signals, etc.) and/or to compile signals that were transmitted within a predetermined time interval, or measurement interval, using various techniques (e.g., integration, photon counting, etc.). By way of example, at least some of the signals may be filtered via a ramp-shaped filter kernel to emphasize high frequencies aspects of the signals (e.g., to promote more defined edges in images generated based upon the signals). The compiled signals are typically in projection space and are, at times, referred to as projections.

The data and/or projections generated by the data acquisition component 118 may be transmitted to an image generator 120 configured to convert the data from projection space to image space using suitable analytical, iterative, and/or other reconstruction techniques (e.g., tomosynthesis reconstruction, iterative reconstruction, etc.). As an example, an iterative reconstruction technique may be applied wherein a first image is reprojected, enhanced, and/or reconstructed multiple times to reduce a ghosting effect (e.g., due to an incomplete volumetric data set for respective locations within the object caused by respective locations being viewed a limited number of times).

In some embodiments, one or more two-dimensional images are generated by the image generator 120 and are respectively focused on a surface of the object (e.g., a two-dimension manifold of the object). For example, a first two-dimensional image may be focused on a first surface and a second two-dimensional image may be focused on a second surface. The first two-dimensional image may be generated based upon data corresponding to rays of radiation that converge at locations on the first surface and the second two-dimensional image may be generated based upon data corresponding to rays of radiation that converge at locations on the second surface. Respective surfaces may be planar or non-planar. Moreover, in some embodiments, the data may be compiled and/or interpolated to generate a volumetric image and/or to acquire volumetric information about the object 104 (e.g., an approximate location, in three-dimensional space, of an item inside the object).

The example system or environment 100 also includes a terminal 122, or workstation (e.g., a computer), configured to receive information about the object 104 such images generated by the image generator 120, alerts regarding possible identification of an item of interest (e.g., from an item detection component configured to analyze the data yielded from the data acquisition component 118 and/or images generated by the image generator 120), etc. The information received by the terminal 122 can be displayed on a monitor 124 to a user 126 (e.g., quality inspector, security personnel, etc.). In this way, the user 126 can identify items of interest and/or verify results of an item detection component, for example. Further, the terminal 122 may be configured to receive user input which can direct operations of the examination unit 102 and/or alter how information is presented to the user 126. As an example, in some embodiments, the terminal 122 may be configured to receive user input defining and/or selecting a surface of the object 104 that is of interest and/or defining a number of two-dimensional images to generate (e.g., thus defining a desired number of surfaces). By way of example, one or more defects in a tire may be more likely to occur at a known location. Thus, a quality inspector may request that the image generator 120 generate an image focused on a surface that includes the known location to facilitate an examination of the known location for defects.

A controller 128 is operably coupled to the terminal 122 and is configured to control operations of the examination unit 102. By way of example, in some embodiments, the controller 128 may be configured to translate instructions received from the terminal 122 into commands for the examination unit 102.

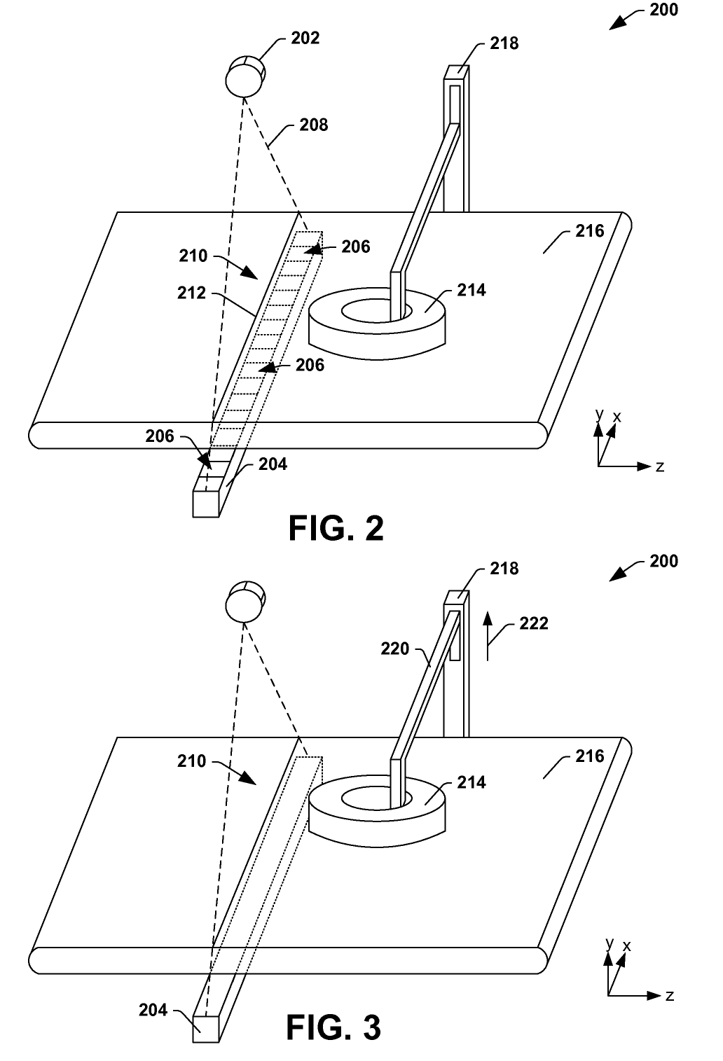

FIG. 2 illustrates a perspective view of an examination unit 200 (e.g., 102 in FIG. 1) wherein a housing (e.g., 110 in FIG. 1) is removed to show an interior portion of the examination unit 200. The examination unit 200 comprises a radiation source 202 (e.g., 106 in FIG. 1) and a detector array 204 (e.g., 108 in FIG. 1). The detector array 204 comprises a plurality of detector cells 206 typically arranged into columns and rows. The number of columns and/or rows may depend upon, among other things, a desired resolution of images yielded from the examination.

In the illustrated embodiment, the detector array 204 comprises a single row of detector cells 206 extending in a fan-angle direction (e.g., along the x-axis) and a plurality of columns of detector cells 206 (e.g., where respective columns merely comprise a single detector cell) extending in the cone-angle direction (e.g., along the z-axis). Moreover, due to the detector array 204 comprising a single row of detector cells 206, the radiation source 202 is configured to emit fan-beam radiation 208 (e.g., which has little to no outwardly expansion in the cone-angle direction). Thus, an examination region 210 (e.g., 112 in FIG. 1) formed between the radiation source 202 and the detector array 204 substantially corresponds to a vertical plane (e.g., with little to no dimension in the cone-angle direction). For purposes of this example, an examination line 212 has been superimposed to represent a fan-angle component of the examination region 210. At a given instant in time, aspects of an object 214 (e.g., 104 in FIG. 1) intersecting the examination line 212 are being examined (e.g., while other aspects of the object 214 not intersecting the examination line 212 are not being examined).

The examination unit 200 further comprises an object support (e.g., 116 in FIG. 1), which in the example embodiment, comprises a conveyor belt 216 and an articulating arm 218. The conveyor belt 216 is configured to translate the object 214 through at least a portion of the examination unit 200 and/or to position the object 214 proximate the articulating arm 218. The articulating arm 218 is configured to lift the object 214 from the conveyor belt 216, translate the object 214 through the examination region 210, and/or rotate the object 214 about an axis substantially perpendicular to a detection surface of the detector array 204 (e.g., in the x-z plane). Due to the articulating arm 218 being configured to rotate the object 214 about the axis, the articulating arm 218 may sometimes be referred to herein as an object rotator. The speed of rotation and/or speed of translation may be application specific and/or may depend upon a desired sampling density (e.g., where the sampling density is a function of the number of angles from which a location is viewed). By way of example, in some embodiments, the articulating arm 218 is configured to rotate the object 214 a full 360 degrees for every one centimeter translation of the object 214 in the z-direction.

FIGS. 3-6 illustrate an example operation of the examination unit 200 (e.g., wherein lines delineating respective detector cells 206 have been removed for ease of understanding). The conveyor belt 216 may be configured to feed the object 214 into the examination unit 200 and to position the object 214 proximate the articulating arm 218. Sensing the proximity of the object 214 to the articulating arm 218, the articulating arm 218 may maneuver a grapple portion 220 of the articulating arm 218 towards the object 214 to make contact with the object 214. Once the grapple portion 220 is connected to the object 214, the grapple portion 220 of the articulating arm 218 may be raised 222, as shown in FIG. 3, to suspend the object 214 (e.g., such that the object 214 is not in contact with the conveyor belt 216).

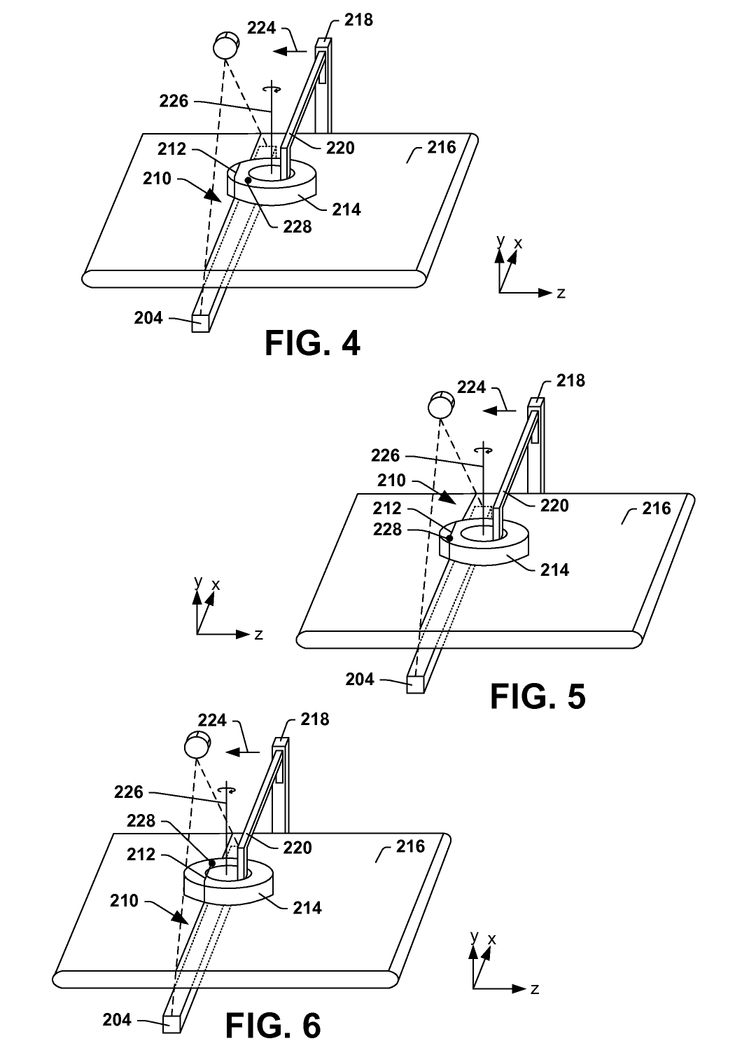

With the object 214 suspended above the conveyor belt 216, the articulating arm 218 may translate 224 the object 214 in the cone-angle direction toward and/or through the examination region 210 as illustrated in FIGS. 4-6. Numerous techniques are contemplated for translating 224 the object 214 toward and/or through the examination region 210. By way of example, in some embodiments, the articulating arm 218 may be attached to a rail that extends in the cone-angle direction and the articulating arm 218 may be configured to be maneuvered along the rail, causing the articulating arm 218 and object 214 to be translated 224 in the cone-angle direction. In other embodiments, the object 214 may be translated 224 without physically moving the articulating arm 218. For example, the grapple portion 220 may be configured to pivot on the articulating arm 218 to translate the object toward and/or through the examination region. Moreover, while reference is made herein to an articulating arm 218 configured to translate and/or rotate the object 214, other suitable devices for performing such translation and/or rotation are also contemplated.

In FIGS. 4-6, the examination line 212 has been superimposed onto the object 214 to illustrate which portion of the object 214 is presently being examined. While the object 214 (e.g., or rather a portion thereof) is being examined, the articulating arm 218 or a grapple portion 220 thereof is configured to rotate the object 214 about an axis of rotation 226. In some embodiments, the axis of rotation 226 is substantially perpendicular to a detection surface of the detector array 204. Moreover, in some embodiments, the object 214 is rotated while continuing to be translated in the z-direction.

As shown in FIG. 4, during a first period of the examination, a first location 228 on the object (e.g., as represented by the black dot) may not be examined. However, due to object 214 being (e.g., concurrently) translated and rotated during the examination, the first location 228 on the object may be examined during other periods of the examination. For example, during a second period of time as shown in FIG. 5, the first location 228 is examined for a first time, and during a third period of time as shown in FIG. 6, the first location 228 is examined for a second time. In this way, by rotating the object 214 and translating the object during the examination, respective locations within the object are viewed multiple times during an examination and are viewed from different angles, as will be explained in more detail below.

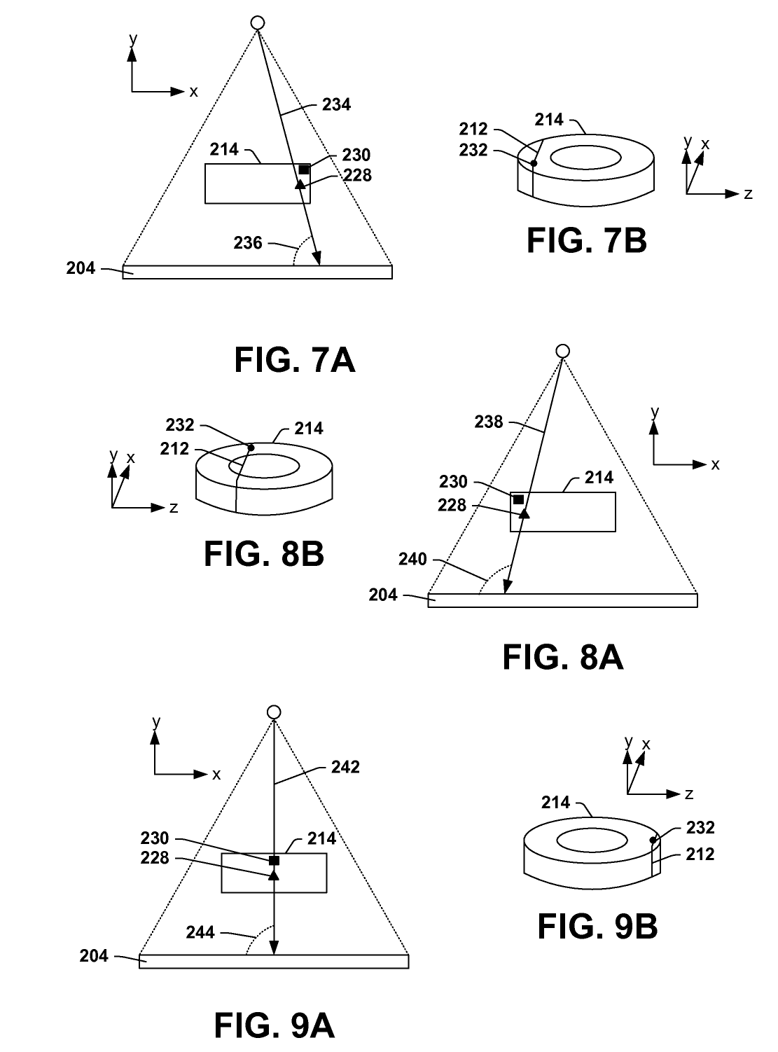

FIGS. 7-9 illustrate how a first set of rays of radiation, respectively having a different trajectory, can intersect the first location 228 (e.g., represented by the black triangle) to facilitate viewing the first location 228 from multiple angles. Data corresponding to this first set of rays can then by processed (e.g., via tomosynthesis techniques) to create a first image depicting a first surface of the object 214 that includes the first location 228. Further, data corresponding to a second set of rays (e.g., which may include one or more rays of the first set) intersecting a second location 230 (e.g., represented by the black rectangle) can be processed to create a second image depicting a second surface of the object 214 that includes the second location 230, for example.

FIGS. 7a, 8a, and 9a represent a cross-sectional view of the examination unit 200 at the examination line 212, where the object 214 is translated into and/or out of the page. FIGS. 7b, 8b, and 9b respectively represent a perspective view of the object 214 whereon the examination line 212 has been superimposed. Moreover, a dot 232 has been superimposed on a surface of the object 214 to represent an approximate x-coordinate and z-coordinate of the first location 228 and the second location 230 relative to the examination line 212.

Turning to FIG. 7a, a cross-sectional view of the examination unit 200 and the object 214 during a first period of time (e.g., such as shown in FIG. 5) is provided. During the first period of time, the first location 228 and the second location 230 are proximate a front of the examination line 212 on the page (e.g., as evident from FIG. 7B). A first ray 234 intersecting the first location 228 and having a first trajectory is drawn on the cross-section view. The first ray passes to the left of the second location 230 (e.g., not intersecting the second location 230) and intersects the detector array 204 at a first fan-angle 236.

Turning to FIG. 8a, a cross-sectional view of the examination unit 200 and the object 214 during a second period of time (e.g., such as shown in FIG. 6) is provided. During the second period of time, the first location 228 and the second location 230 are proximate a back of the examination line 212 on the page and the examination line has moved slightly to the right on the page (e.g., as evident from FIG. 8b) (e.g., relative to where the examination line 212 was located relative to the object 214 during the first period of time). A second ray 238 intersecting the first location 228 and having a second trajectory is drawn on the cross-section view. The second ray 238 passes to the right of the second location 230 (e.g., not intersecting the second location 230) and intersects the detector array 204 at a second fan-angle 240.

Turning to FIG. 9a, a cross-sectional view of the examination unit 200 and the object 214 during a third period of time is provided. During the third period of time, the first location 228 and the second location 230 are proximate a center of the examination line 212 on the page and the examination line 212 has moved further to the right on the page (e.g., as evident from FIG. 9b) (e.g., relative to where the examination line 212 was located relative to the object 214 during the first period of time and/or the second period of time). A third ray 242 intersecting the first location 228 and having a third trajectory is drawn on the cross-section view. The third ray 242 intersects the second location 230 and intersects the detector array 204 at a third fan-angle 244.

By comparing the trajectory of the first ray 234, the second ray 238, and the third ray 242, it may be evident that first ray 234, second ray 238, and the third ray 242 converge at the first location 228 (e.g., such that the only location where all three rays intersect is the first location 228). Accordingly, using data corresponding to the first ray 234, the second ray 238, and the third ray 242 (e.g., respectively having a different fan-angle 236, 240, 244), an approximate attenuation caused by a portion of the object at the first location 228 can be determined and/or an estimated density, z-effective, or other characteristic of the portion of the object at the first location 228 can be determined. Moreover, the data corresponding to the first ray 234, the second ray 238, and the third ray 242 can be combined with data corresponding to other rays that converge along other locations intersecting a desired surface of the object 214 to generate an image representing (e.g., focused on) the desired surface.

It may be appreciated that due to the nature of rotating an object 214 about an axis of rotation 226, the sampling density (e.g., which is a function of the number of angles from which a location is viewed) may vary across the object 214 (e.g., causing aspects of the object 214 closer to the axis of rotation 226 to appear brighter) in some embodiments. For example, the sampling density at locations near an axis of rotation 226 may be greater than the sampling density at locations further from the axis of rotation 226.

In some embodiments, such variations in sampling density may be compensated using software approaches and/or hardware approaches. By way of example, in some embodiments, the projection data generated by a data acquisition component (e.g., 118 in FIG. 1) may be weighted based upon the distance between the portion of the object 214 represented by the projection data and an axis of rotation 226. For example, projection data corresponding to a portion of the object 214 further away from the axis of rotation 226 may be weighted more than projection data corresponding to a portion of the object 214 closer to the axis of rotation 226. As another example, in some embodiments, a sample rate of one or more detector cells of the detector array 204 may be adjusted based upon the distance between the portion of the object 214 being examined and the axis of rotation 226. By way of example, the sampling rate of at least some detector cells may be decreased as the axis of rotation 226 approaches the examination field. By way of example, the sampling rate of detector cells near a central portion of the detector array 204 (e.g., close to the axis of rotation 226) may decrease while the sampling rate of detector cells in more distal portions of the detector array 204 may increase or at least not be decreased because those distal cells are farther away from the axis of rotation 226.

Further, it may be appreciated that while reference is made herein to rotating the object 214, in some embodiments, the detector array 204 may also be rotated such as described in International Publication WO/2012/173597 which is incorporated herein by reference. In some embodiments, the detector array 204 is rotated about a second axis of rotation which may be parallel to the first axis of rotation, for example. Further, in some embodiments, the object support may be configured to rotate the object 214 in a different direction that the detector array 204 is rotated. By way of example, the object support may be configured to rotate the object 214 in a first direction (e.g., clockwise) and the detector array 204 may be rotated in a second direction (e.g., counter-clockwise) that is opposite to the first direction. In this way, a sampling density may be increased (e.g., to increase a number of surfaces that can be represented in images and/or to improve a resolution of the images), for example.

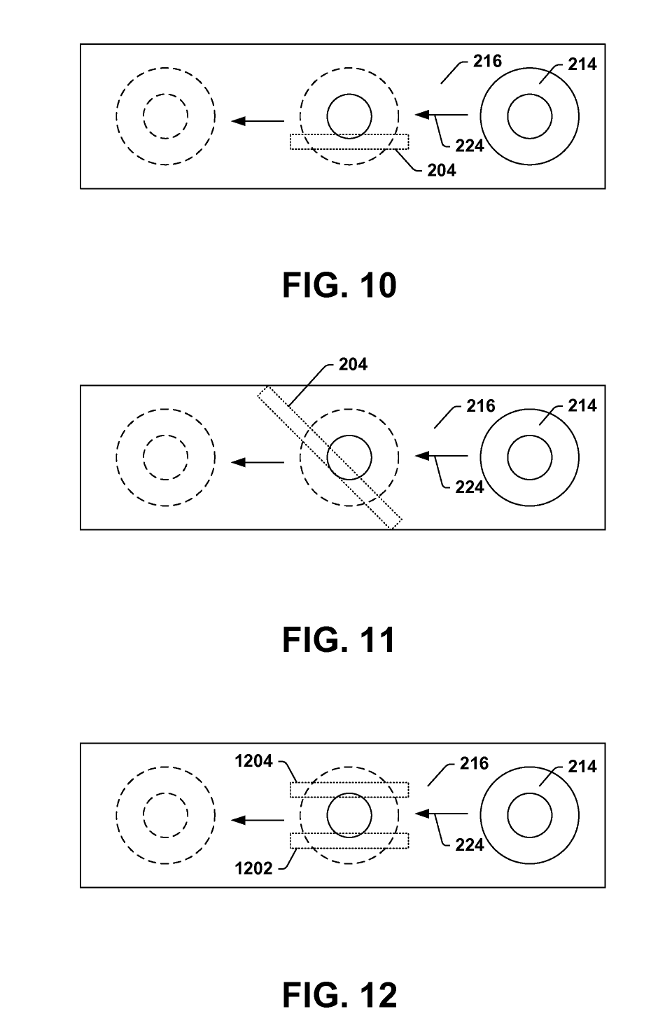

Moreover, while FIGS. 2-9 describe a detector array 204 as having a single row of detector cells extending in the fan-angle direction, the orientation of the detector array 204 may be determined on an application-by-application basis based upon the object(s) to be examined and/or desired image parameters, for example. By way of example, FIGS. 10 and 11 illustrate top-down views of other example orientations of the detector array 204. More specifically, FIG. 10 illustrates an example detector array 204 having a longitudinal dimension (e.g., a longest dimension) extending in the cone-angle direction (e.g., the row of detector cells extends in a direction parallel to the direction of translation 224), and FIG. 11 illustrates an example detector array 204 having a longitudinal dimension extending diagonally across the conveyor belt 216.

Further, it is to be appreciated that in some embodiments, the detector array 204 may comprise multiple rows of detector cells and multiple columns of detector cells and/or the examination unit 102 may comprise multiple detector arrays. By way of example, FIG. 12 illustrates a top-down view of a portion of an examination unit comprising two detector arrays 1202, 1204 (e.g., respectively comprising a single row of detector cells) which respectively have a longitudinal dimension extending in the cone-beam direction.

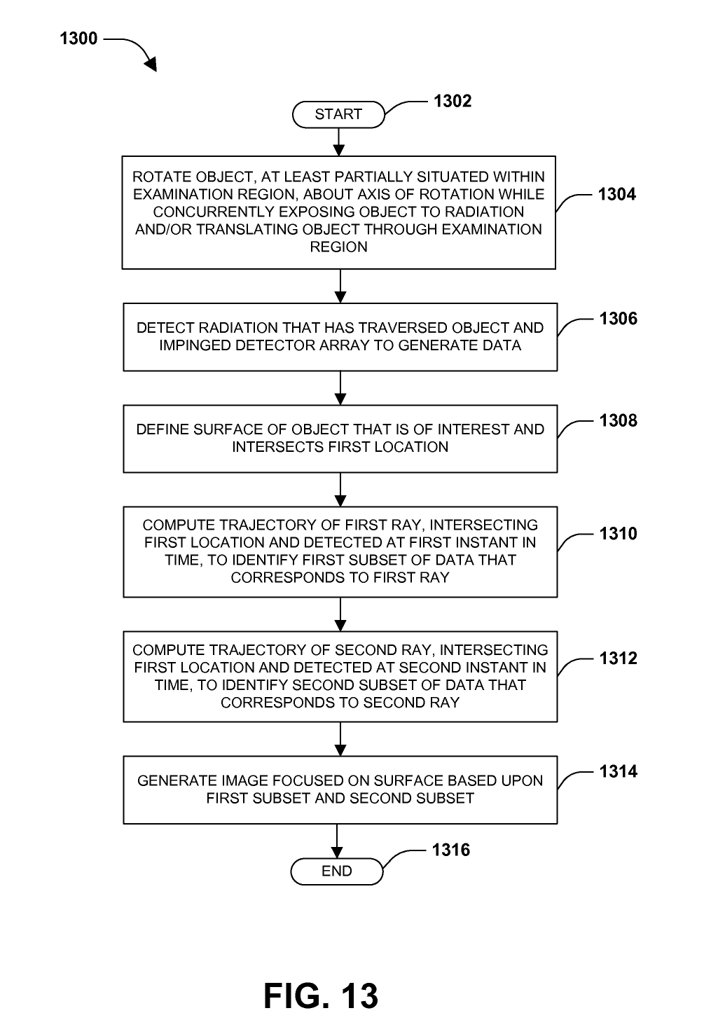

Referring to FIG. 13, a flow diagram of an example method 1300 for examining an object via radiation, such as x-ray radiation and/or gamma radiation is provided. The method 1300 starts at 1302, and an object, at least partially situated within an examination region, is rotated about an axis of rotation during an examination of the object at 1304 while concurrently exposing the object to radiation and/or while concurrently translating the object through the examination region. In some embodiments, the axis of rotation is substantially perpendicular to a detection surface of a detector array of a radiation system configured to examine the object. In other embodiments, the axis of rotation is angled at an angle of other than 90 degrees relative to the detection surface.

At 1306 in the example method 1300, radiation that has traversed the object and impinged the detector array is detected to generate data.

At 1308 in the example method 1300, a surface of the object that is of interest is defined. The surface may be planar or non-planar and intersects a first location within the object. In some embodiments, the surface corresponds to a cross-sectional slice of the object that is substantially parallel to a detection surface of the detector array. In some embodiments, the surface is defined based upon user input. In some embodiments, the surface is defined based upon a desired number of images to be produced and/or a sampling density of the data.

At 1310 in the example method 1300, a trajectory of a first ray, intersecting the first location and detected during a first period of time, is computed to identify a first subset of the data that corresponds to the first ray. At 1312 in the example method 1300, a trajectory of a second ray intersecting the first location and detected during a second period of time, is computed to identify a second subset of the data that corresponds to the second ray. Typically, the first ray and the second ray follow different trajectories. For example, the first ray may intersect the detector array at a first fan-angle and the second ray may interest the detector array at a second fan-angle. Moreover, while the first ray and the second ray are emitted and detected at different times, the first ray and the second ray may be said to (e.g., spatially) converge at the first location because the first ray and the second ray both intersect the first location while having different trajectories (e.g., and thus diverge at other locations within the object).

At 1314 in the example method 1300, an image is generated that is focused on the surface based upon the first subset of the data and the second subset of the data (e.g., as well as other subsets of the data corresponding to rays of radiation converging at locations along the surface).

The example method 1300 ends at 1316.

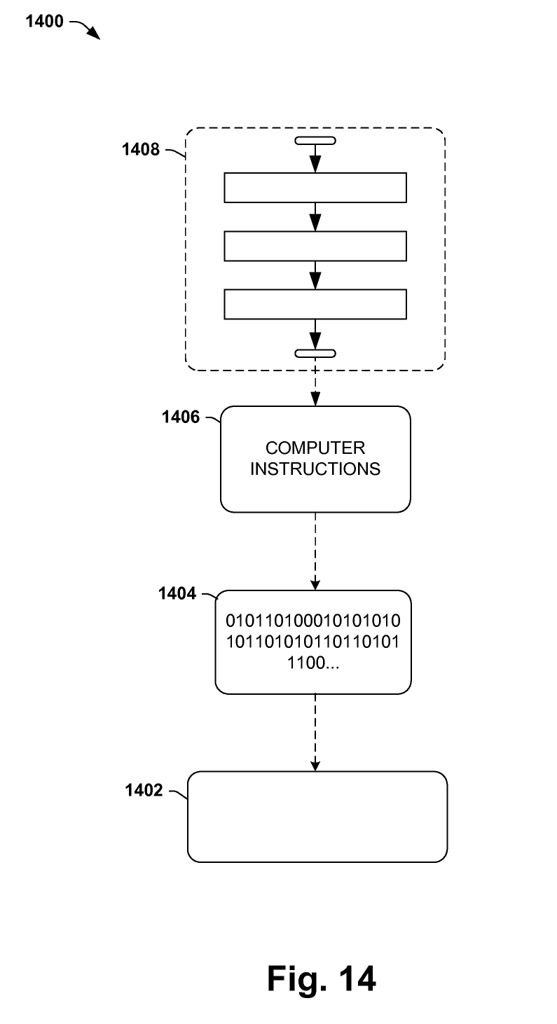

Still other embodiments involve a computer-readable medium comprising processor-executable instructions configured to implement one or more of the techniques presented herein. An example computer-readable medium that may be devised in these ways is illustrated in FIG. 14, wherein the implementation 1400 comprises a computer-readable medium 1402 (e.g., a flash drive, CD-R, DVD-R, application-specific integrated circuit (ASIC), field-programmable gate array (FPGA), a platter of a hard disk drive, etc.), on which is encoded computer-readable data 1404. This computer-readable data 1404 in turn comprises a set of processor-executable instructions 1406 configured to operate according to one or more of the principles set forth herein. In some embodiments, the processor-executable instructions 1406 may be configured to perform an operation 1408 when executed via a processing unit, such as at least some of the example method 1300 of FIG. 13. In other embodiments, the processor-executable instructions 1406 may be configured to implement a system, such as at least some of the example radiation system 100 of FIG. 1. Many such computer-readable media may be devised by those of ordinary skill in the art that are configured to operate in accordance with one or more of the techniques presented herein.

Although the subject matter has been described in language specific to structural features or methodological acts, it is to be understood that the subject matter of the appended claims is not necessarily limited to the specific features or acts described above. Rather, the specific features and acts described above are disclosed as embodiment forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. The claimed subject matter may be implemented as a method, apparatus, or article of manufacture (e.g., as software, firmware, hardware, or any combination thereof).

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. (e.g., “a first channel and a second channel” generally corresponds to “channel A and channel B” or two different (or two identical) channels or the same channel).

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A radiation system, comprising:
a radiation source configured to emit radiation into an examination region wherein an object is exposed to the radiation during an examination;
a detector array configured to detect radiation that traverses the examination region; and
an object support configured to rotate the object about an axis of rotation and to translate the object relative to the detector array such that first data, indicative of a first ray of radiation having a first trajectory and intersecting a first location within the object, and second data, indicative of a second ray of radiation ray having a second trajectory and intersecting the first location within the object, is yielded from the examination.

2. The radiation system of claim 1, wherein the detector array contains a single row of detector cells.

3. The radiation system of claim 1, wherein the detector array is in a fixed position relative to the examination region.

4. The radiation system of claim 1, wherein the axis of rotation is substantially perpendicular to a detection surface of the detector array.

5. The radiation system of claim 1, comprising an image generator configured to generate an image focused on first surface of the object.

6. The radiation system of claim 5, wherein the first surface is defined by a user.

7. The radiation system of claim 1, wherein the detector array is rotatable about a second axis of rotation.

8. The radiation system of claim 7, wherein the second axis of rotation is parallel to the first axis of rotation.

9. The radiation system of claim 7, wherein the object support is configured to rotate the object in a first direction and the detector array is rotatable in a second direction that is opposite the first direction.

10. The radiation system of claim 1, wherein the object support is configured to concurrently translate and rotate the object.

11. The radiation system of claim 1, wherein the detector array comprises a single row of detector cells extending in a direction substantially parallel to a direction of translation of the object through the examination region.

12. The radiation system of claim 1, comprising an image generator configured to generate an image of the object via tomosynthesis reconstruction.

13. The radiation system of claim 1, the radiation source comprising an ionizing radiation source.

14. The radiation system of claim 1, the radiation source configured to emit fan-beam radiation.

15. A method for examining an object via radiation, comprising:
rotating the object, at least partially situated within an examination region, about an axis of rotation while concurrently exposing the object to radiation;
translating the object through the examination region; and
detecting radiation that has traversed the object and impinged a detector array to generate data, wherein:
a first subset of the data is indicative of a first ray of radiation having a first trajectory and intersecting a first location within the object, and
a second subset of the data is indicative of a second ray of radiation having a second trajectory and intersecting the first location within the object.

16. The method of claim 15, the translating occurring concurrently with the rotating.

17. The method of claim 15, comprising:
computing a trajectory of the first ray, intersecting the first location and detected during a first period of time, to identify the first subset; and
computing a trajectory of the second ray, intersecting the first location and detected during a second period of time, to identify the second subset.

18. The method of claim 15, comprising:
defining a surface of the object that is of interest based upon user input, the first location intersecting the surface.

19. The method of claim 15, the first ray intersecting the detector array at a first fan-angle and the second ray intersecting the detector array at a second fan-angle.

20. A computer readable medium comprising instructions that when executed perform operations, comprising:
rotating an object, at least partially situated within an examination region, about an axis of rotation while concurrently translating the object through the examination region and exposing the object to radiation;
detecting radiation that has traversed the object and impinged a detector array to generate data;
defining a surface of the object that is of interest, a first location within the object intersecting the surface;
computing a trajectory of a first ray, intersecting the first location and detected during a first period of time, to identify a first subset of the data;
computing a trajectory of a second ray, intersecting the first location and detected during a second period of time, to identify a second subset of the data; and
generating an image, focused on the surface, based upon the first subset and the second subset.
